(19) United States
(12) Patent Application Publication
(10) Pub. No.: US 2022/0407273 A1
(43) Pub. Date: Dec. 22, 2022

(54) ELECTRICAL CONTACT ARRANGEMENT

(71) Applicant: cutpack.com GmbH, Fussach (AT)

(72) Inventor: Remo EGGER, Langenegg (AT)

(73) Assignee: cutpack.com GmbH, Fussach (AT)

(21) Appl. No.: 17/775,691

(22) PCT Filed: Jun. 5, 2020
(86) PCT No.: PCT/AT2020/000013

§ 371 Date: May 10, 2022

(30) Foreign Application Priority Data
Nov. 20, 2019 (AT) A 377/2019

(51) Int. Cl. H01R 39/64; H01R 39/28

(52) U.S. Cl. CPC H01R 39/643; H01R 39/28

(57) ABSTRACT

An electrical contact arrangement comprising at least one pair of contacts which is formed by a primary and a secondary contact ring (11, 12) which can be rotated in relation to one another about a longitudinal center axis (16) and each have a conical shell-like contact face (11d, 12d) which surrounds the longitudinal center axis (16), and at least one roller (27) which rolls between the primary and the secondary contact ring (11, 12) and is rotatably mounted about a rotation axis (28) which is at a right angle to the longitudinal center axis (16). The roller (27) has a conical shell-like contact surface (27a) which surrounds the rotation axis (28) and respectively forms a line contact, which runs along a respective contact line (31, 32), with the contact faces (11d, 12d) of the primary and secondary contact rings (11, 12).

### TECHNICAL FIELD

The invention relates to an electrical contact arrangement comprising at least one pair of contacts formed by a primary and a secondary contact ring, which can be rotated with respect to one another about a longitudinal center axis and each of which has a contact surface which is in the form of a cone envelope and surrounds the longitudinal center axis, wherein the secondary contact ring is arranged on a rotor mounted rotatably with respect to a housing, at least one roller, which rolls between the primary and the secondary contact ring of a respective pair of contacts and is mounted rotatably about an axis of rotation at right angles to the longitudinal center axis, wherein the roller has a contact surface which is in the form of a cone envelope, surrounds the axis of rotation, and forms a respective line contact, running along a respective contact line, with the contact surfaces of the primary and secondary contact rings, and at least one spring element, which presses the contact surface of the roller against the contact surfaces of the primary and secondary contact rings, wherein the spring force of the at least one spring element acts parallel to the longitudinal center axis.

### BACKGROUND

Different embodiments of electrical contact arrangements for transmitting electrical energy or electrical signals to rotating parts are known. For example, such electrical contact arrangements are used in machine tools, in particular multi-axis machine tools, e.g. to operate electrically operated clamping means. If the contact arrangement is used to transmit electrical energy, depending on the application high current intensities to be transmitted can arise, for example in the region of above 50 A, which can be direct current or alternating current depending on the usage situation. Likewise depending on the usage situation, the rotational speeds that occur can be high and it may additionally also be necessary to transmit energy at a standstill.

In a common usage situation, in addition to the electrical contact connection a fluid transfer is also necessary. A rotary feedthrough is therefore necessary in addition to the electrical contact arrangement.

Likewise, it is often the case that it is necessary to transmit on the one hand electrical energy, for example in the form of drive energy for an electrical unit, and on the other hand electrical signals, for example to control an electrical unit.

In order to transmit direct current to rotating parts, carbon brush systems, which, among other things, are disadvantageous in terms of the maintenance outlay and the transmission of energy at a standstill, are known.

Contactless transmitters, which can transmit only low power and only alternating current, are also known.

What are referred to as gold wire systems are also known. In the case of these gold wire systems, a fixed contact finger presses on a circular surface. The rotational speeds that can be achieved are low and the wear is high.

In addition, electrical contact arrangements in which the current is transmitted via rolling bodies rolling between contact surfaces are known. Thus, one of the exemplary embodiments shown in WO 2016/032336 A1 discloses a contact arrangement in which contact rollers are pressed against oppositely situated contact rings, one of which is fixed and the other of which rotates about a longitudinal center axis. The contact rollers are mounted rotatably about axes of rotation at right angles to the longitudinal center axis. The contact rings have contact surfaces which are in the form of a cone envelope and, in the region of the contact connection, the rollers have contact surfaces which are curved in the form of a spherical surface when viewed in central longitudinal section. The contact surfaces of the rollers are pressed against the oppositely situated contact surfaces of the contact rings by means of springs, which act in the axial direction of the axes of rotation. The contacts formed are essentially point contacts and the contact force is dependent on the rotational speed, owing to the centrifugal force acting on the rollers.

An electrical contact arrangement in which balls in the form of rolling bodies are arranged between bearing shells is disclosed in DE 31 50 427 A1. This contact arrangement is not suitable for high rotational speeds and the use of balls as rolling bodies provides only a Hertzian point contact surface for low currents.

In the contact arrangement known from DE 192 16 855 B4, contact rollers which have resilient contact sheets protruding helically outward are arranged between an inner conductor and an outer conductor arranged coaxially therewith. These contact sheets are very susceptible to wear, not very advantageous in terms of the contact connection. Further contact arrangements with rolling bodies are disclosed, for example, in DE 32 14 083 C2, WO 98/05104 A1 and DE 19 41 309 A.

A contact arrangement of the type mentioned at the outset is disclosed in WO 02/01682 A1. Here, the roller that rolls between the primary and the secondary contact ring of the contact fitting has a contact surface which is in the form of a cone envelope and surrounds the axis of rotation. Thus forms a respective line contact, running along a respective contact line, with the contact surfaces of the primary and secondary contact rings. The contact surfaces of the primary and secondary contact rings are pressed against the contact surface of the at least one roller by a spring force. However, the manufacture must be carried out with very high degree of precision in order to actually form line contacts. In practice, the formation of such line contacts can be disrupted by manufacturing tolerances and/or abrasion in the course of operation.

### SUMMARY

The object of the invention is to provide an advantageous electrical contact arrangement of the type mentioned at the outset, which can also be used for relatively high currents and is preferably suitable both for low and high rotational speeds and for the transmission of current at a standstill. According to the invention, this is achieved by a contact arrangement having one or more of the features disclosed herein.

In the contact arrangement according to the invention, a support portion of the secondary contact ring rests on a rotor base part of the rotor and a contact portion of the secondary contact ring, which contact portion comprises the contact surface, adjoins the support section radially to the outside. A support portion of the primary contact ring rests on a pressure plate, which is acted upon by at least one spring element and is mounted axially displacably with respect to a housing part of the electrical contact arrangement. A contact portion of the primary contact ring adjoins the support portion radially to the outside and comprises the contact surface. The angle, measured on the side of the contact surface, between the contact portion and the support portion of the respective primary and secondary contact ring is greater in the assembled state than in the unloaded state. As a result, in the assembled state, the inclinations of the contact portions match the inclination of the contact surface of the respective roller with which they interact.

The design according to the invention achieves a reliable contact connection and allows high currents to be transmitted.

The contact surface of the at least one roller is preferably prestressed against the contact surfaces of the primary and secondary contact rings by at least one spring element acting on one of the contact rings, wherein the spring force acts parallel to the longitudinal center axis. As a result, the contact pressure is at least substantially independent of the rotational speed. The contact arrangement according to the invention is therefore also suitable for high rotational speeds.

A contact arrangement according to the invention is also advantageously suitable for the transmission of current at a standstill.

The contact lines, which form the contact surface of the roller or a respective one of the rollers with the contact surfaces of the primary and secondary contact rings, advantageously lie on straight lines that intersect on the longitudinal center axis of the contact arrangement, wherein they form a common intersection point with the axis of rotation about which the respective roller is rotatably mounted. As a result, when the primary and secondary contact rings rotate with respect to one another, the roller rolls on the contact surfaces of the primary and secondary contact rings over the entire width of the line contacts that are formed, at least substantially without slipping.

In a preferred embodiment of the invention, there are at least three rollers, which are arranged around the longitudinal center axis preferably so as to be uniformly spaced apart, are mounted rotatably about axes of rotation at right angles to the longitudinal center axis, have contact surfaces in the form of a cone envelope, and roll between the primary and the secondary contact ring. In this way, it is possible to have the effect that a roller support ring, which mounts the rollers rotatably about the respective axis of rotation, is aligned coaxially with the longitudinal center axis of the contact arrangement solely by virtue of the rollers rolling on the primary and the secondary contact ring. Additional mounting of the roller support ring around the longitudinal center axis can thus be omitted.

An electrical contact arrangement according to the invention may additionally have a ball contact unit for the purpose of transmitting electrical signals (of low current intensity). This ball contact unit can advantageously comprise at least one contact disk with multiple annular conductor tracks, at least one set of multiple mutually coaxial annular mating contacts, the diameters of which correspond to the diameters of the annular conductor tracks, at least one ball guiding disk, which is arranged between the at least one contact disk and the mating contacts interacting with the contact disk, and contact balls, which are guided by the ball guiding disk and roll between a respective one of the conductor tracks and the annular mating contact belonging to this conductor track. In this respect, at least one spring element preferably interacts with each of the annular mating contacts, which spring element presses the annular mating contact against the balls rolling between this mating contact and the associated conductor track.

An electrical contact arrangement according to the invention may be combined with a rotary feedthrough for fluids.

A contact arrangement according to the invention can be used advantageously to transmit electrical energy to a rotating electrical unit, in particular an electric drive corotating with a rotating part, for example a clamping means of a machine tool, in particular a multi-axis machine tool. A contact arrangement according to the invention is also suitable for transmitting electrical energy from a rotating part, for example a rotor of a generator, to a stationary part.

A contact arrangement according to the invention makes it possible to transmit relatively high currents, which, for example, can be above 50 A or, depending on the usage situation, even above 200 A.

Unless stated otherwise in the present document, a reference to the “axial direction” refers to the longitudinal center axis of the contact arrangement.

### BRIEF DESCRIPTION OF THE DRAWINGS

Further advantages and details of the invention are explained below with reference to the appended drawing, in which:

FIG. 1 shows an oblique view of an exemplary embodiment of an electrical contact arrangement according to the invention in combination with a rotary feedthrough for a fluid;

FIG. 2 shows a central longitudinal section;

FIG. 3 shows an exploded illustration of the cone contact unit, with the rotor not illustrated in exploded form;

FIG. 4 shows an exploded illustration of the rotor of the cone contact unit;

FIG. 5 shows an exploded illustration of the ball contact unit, with the rotor of the ball contact unit not illustrated in exploded form;

FIG. 6 shows an exploded illustration of the rotor of the ball contact unit.

### DETAILED DESCRIPTION

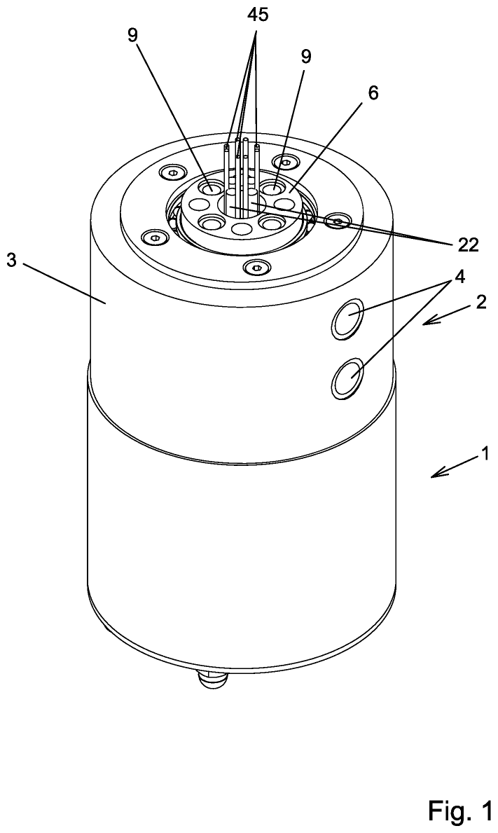

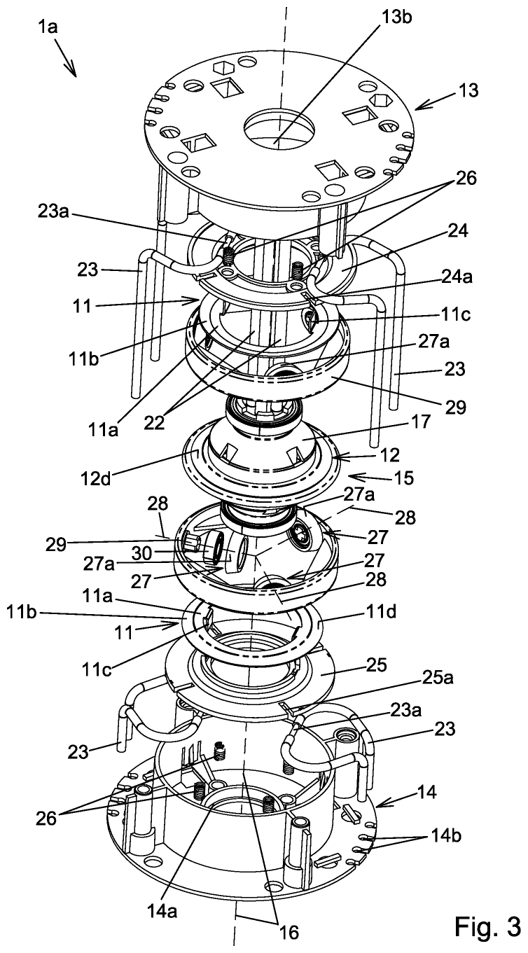

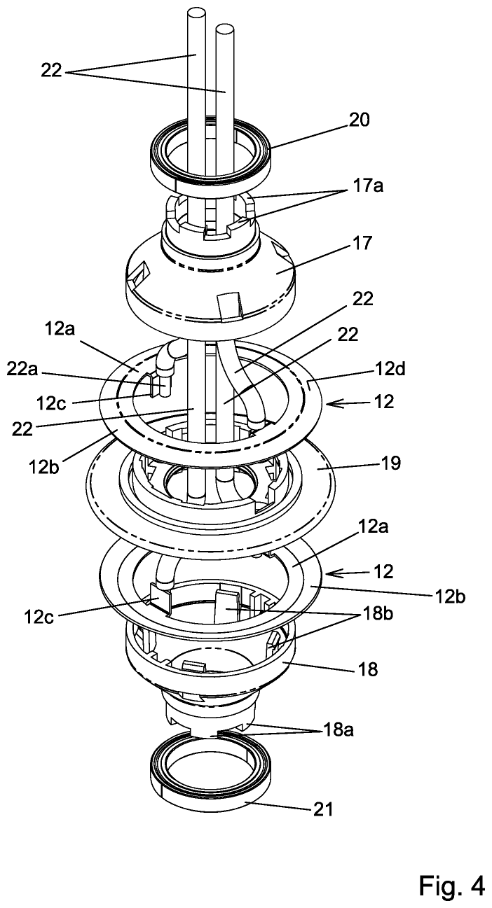

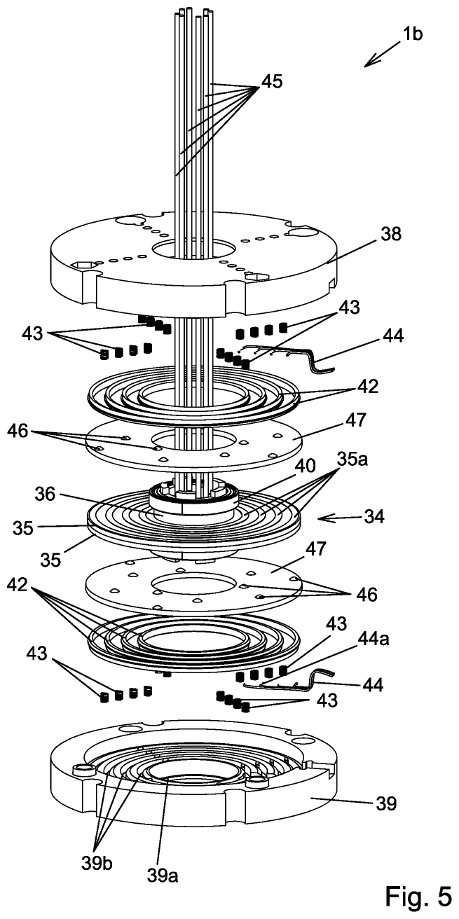

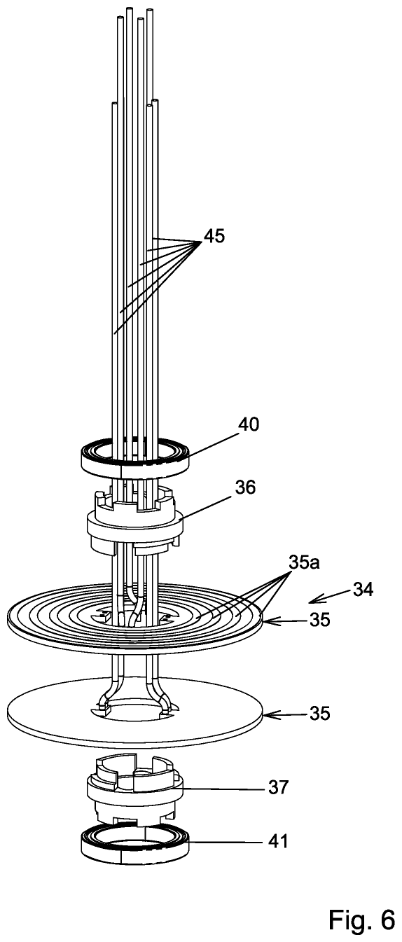

An exemplary embodiment of a contact arrangement according to the invention is described below with reference to FIGS. 1 to 6. In this exemplary embodiment, the contact arrangement 1 according to the invention is combined with a rotary feedthrough 2 for a fluid. As is known, the rotary feedthrough 2 has a housing part 3 substantially in the form of a hollow cylinder. Axially spaced-apart channels 4 for the passage of a fluid, for example air or water, run radially through the housing part 3. The channels 4 proceed from the outer lateral surface and open into an annular groove 5 running around the inner lateral surface. A rotary part 6 is rotatably mounted in the housing part 3, in this instance by means of ball bearings 7, 8. The rotary part 6 has axial channels 9, which open at an axial end of the rotary part 6, for the passage of the fluid. A respective channel 9 is connected to one of the annular grooves 5 via a respective bore 10.

The rotary part 6 has a hollow-cylindrical design. Electrical lines of the electrical contact arrangement 1, which are described in more detail below, are passed through the interior space of the rotary part 6.

However, an electrical contact arrangement according to the invention could also be designed without a rotary feedthrough 2, i.e. the rotary feedthrough 2 could be omitted.

In the exemplary embodiment, the electrical contact arrangement 1 has a cone contact unit 1a and a ball contact unit 1b. The ball contact unit 1b could also be omitted, with the result that the electrical contact arrangement 1 would be formed only by the cone contact unit 1a.

The cone contact unit 1a comprises two pairs of contacts, each pair being formed by a primary contact ring 11 and a secondary contact ring 12. The primary contact rings 11 are held non-rotatably with respect to a housing, which in the exemplary embodiment is formed by the two housing parts 13, 14.

The secondary contact rings 12 are arranged on a rotor 15 which is mounted rotatably with respect to the housing formed by the housing parts 13, 14, specifically about the longitudinal center axis 16 of the contact arrangement.

If the contact arrangement is combined with a rotary feedthrough for a fluid, the rotary part 6 is also mounted rotatably about the longitudinal center axis 16 and the rotary part 6 is rotationally conjointly connected to the rotor 15. For example, to that end a rotor housing part 17 may have prongs 17a and depressions in between, which engage in corresponding depressions and prongs of the rotary part 6.

In the exemplary embodiment, the rotor 15 comprises the rotor housing parts 17, 18 and the rotor base part 19. The secondary contact rings 12 are positioned and held by these parts.

The rotor housing parts 17, 18 may be connected to the rotor base part 19, for example by way of a snap connection, as illustrated. For this purpose, latching arms 17b, 18b comprising latching lugs may be arranged on rotor housing parts 17, 18, which latching arms latch to latching recesses in the rotor base part 19. A screw connection would also be possible, for example.

A different form of the rotor 15 having more or fewer parts is conceivable and possible.

For the rotatable mounting of the rotor 15 with respect to the housing parts 13, 14, inner rings of ball bearings 20, 21 are arranged on the rotor housing parts 17, 18, the outer rings of which are held in seats 13a, 14a of the housing parts 13, 14.

The secondary contact rings 12 each have an annular support portion 12a, which is in a plane at right angles to the longitudinal center axis 16, and an annular contact portion 12b adjoining it radially on the outside. Contacting tabs 12c protrude from the support portion 12a, in particular in the axial direction of the longitudinal center axis 16, to which contacting tabs electrical conductors 22a of cables 22 are connected, for example soldered. In the exemplary embodiment, each secondary contact ring 12 comprises two contacting tabs 12c, it also being possible, for example, for only one contacting tab 12c with a connected electrical conductor 22a to be present per secondary contact ring 12. The contacting tabs 12c could also be omitted and at least one electrical conductor could be fastened directly to the support portion 12a of the respective secondary contact ring 12.

The support portions 12a rest on the rotor base part 19. In the exemplary embodiment, they are clamped in between the respective rotor housing part 17, 18 and the rotor base part 19. Other ways of fastening the secondary contact rings 12 to a rotor base part and/or rotor housing part are conceivable and possible.

The contact portions 12b of the secondary contact rings 12 are aligned at an angle with respect to the respective support portion 12a. That surface of the respective contact portion 12b that interacts with the rollers 27 forms a contact surface 12d. This has the form of a cone envelope.

The contact portions 12b of the secondary contact rings 12 are free in the assembled state. Thus, the contact portions 12b of the secondary contact rings 12 are flexible with respect to the respective support portion 12a, i.e. the angular positions of the contact portions 12b can be changed with respect to the angular positions of the support portions 12a.

The primary contact rings 11 each have an annular support portion 11a, which is in a plane at right angles to the longitudinal center axis 16. A respective contact portion 11b adjoins the support portion 11a radially on the outside and is at an angle in relation to the support portion 11a. That side of the respective primary contact ring 11 that interacts with the rollers 27 forms a contact surface 11d. This has the form of a cone envelope.

In the exemplary embodiment, two respective contacting tabs 11c protrude from the support portions 11a, in particular axially, and are connected to electrical conductors 23a of cables 23, for example by being soldered on. It would also be possible to provide only one contacting tab 11c per primary contact ring 11, or to connect at least one conductor directly to the respective support portion 11a. The connection to the electrical conductors 23a also secures the primary contact rings 11 against rotation about the longitudinal center axis 16 in the exemplary embodiment. As an alternative or in addition, such a rotation-prevention means could also have a different form.

The support portions 11a of the primary contact rings 11 each rest on a pressure plate 24, 25. The pressure plates 24, 25 are held axially displaceably but non-rotatably with respect to the housing parts 13, 14, for example in that ribs of the housing parts 13, 14 protrude into slots 24a, 25a in the pressure plates. Spring elements 26 are arranged between the pressure plates 24, 25 and the respective associated housing part 13, 14. In the exemplary embodiment, these spring elements are in the form of helical springs, with multiple spring elements 26 being arranged around the longitudinal center axis 16. For example, it would also be possible instead to use at least one annular leaf spring as spring element.

The contact portions 11b of the primary contact rings 11 are free in the assembled state. Thus, the contact portions 11b of the primary contact rings 11 are flexible with respect to the respective support portion 11a, i.e. the angular positions of the contact portions 11b can be changed with respect to the angular positions of the support portions 11a.

Rollers 27 run between the primary and the secondary contact ring 11, 12 of a respective pair of contacts. The rollers 27 are mounted rotatably about axes of rotation 28 which are at right angles to the longitudinal center axis 16. For each pair of contacts, there are multiple rollers 27, which are distributed around the longitudinal center axis 16, preferably at equal angular intervals. The axes of rotation 28 of the rollers 27 are therefore at an angle to one another, the angles between successive axes of rotation 28 preferably having the same magnitude.

The rollers 27 consist of an electrically conductive material, at least in the region of the running surfaces.

A respective roller support ring 29 is used for the rotatable mounting of the rollers 27. In the exemplary embodiment, this roller support ring comprises journals 29a which protrude radially inward and on each of which a roller 27 is rotatably mounted, preferably by means of a ball bearing 30.

A respective roller 27 is in the form of a truncated hollow cone. The running surface of the roller forms a contact surface 27a, which has the form of a cone envelope.

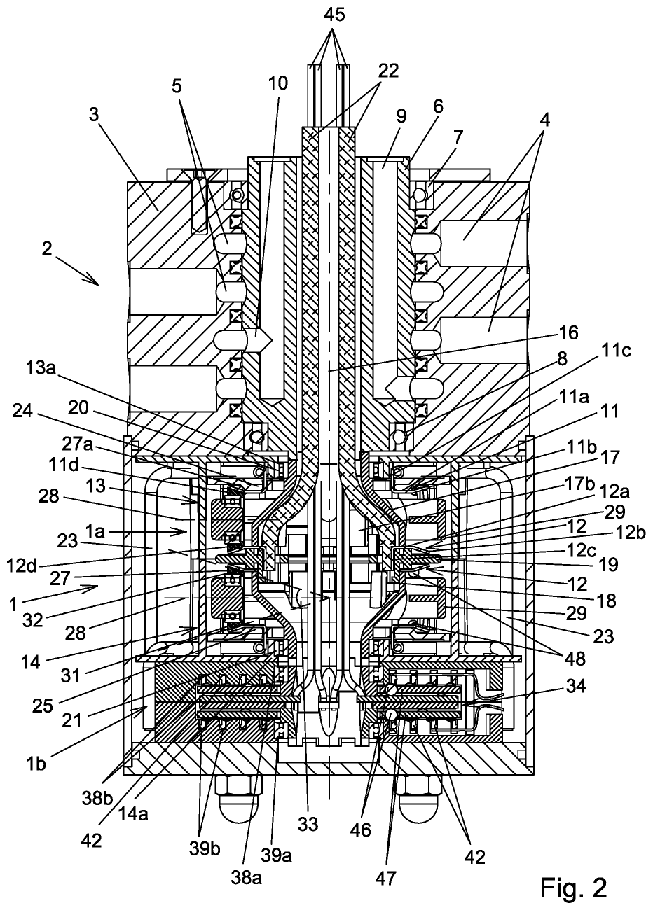

In the assembled state, the contact surfaces 11d, 12d of the primary and secondary contact rings rest on this contact surface 27a over the entire axial extent, with respect to the axis of rotation 28, of the contact surface 27a of a respective roller 27. A respective line contact is thus formed between the contact surface of a respective roller 27 and the contact surfaces 11d, 12d of the associated primary and secondary contact rings 11, 12. The contact is thus made in each case along a contact line 31, 32 constituting the line of contact between the respective contact surface 11d, 12d of the primary or secondary contact ring 11, 12, respectively, and the contact surface 27a of the respective roller 27. This contact line 3, 32 is respectively visible in that central longitudinal section through the contact arrangement that passes through the axis of rotation 28 of the respective roller 27, cf. FIG. 2.

Each of the rollers 27 thus forms a primary contact line 31 with the associated primary contact ring 11 and a secondary contact line 32 with the associated secondary contact ring 12. The primary and the secondary contact line between a respective roller 27 and the associated primary and secondary contact rings 11, 12 lie on straight lines which are at an angle to one another and the intersection point of which lies on the longitudinal center axis 16, cf. FIG. 2. The intersection point of these two straight lines also lies on the axis of rotation 28 of this roller 27. These two straight lines, the longitudinal center axis 16 and the axis of rotation 28 therefore have a common intersection point. The angle 33 formed by these two straight lines is approx. 35° in the exemplary embodiment; this angle 33 is preferably in the range from 25° to 45°, particularly preferably in the range from 30° to 40°.

The primary and secondary contact rings 11, 12 and the rollers 27 are thus pressed against one another by the spring elements 26. The spring elements 26 act on the primary contact rings 11 in the axial direction (in relation to the longitudinal center axis 16) by way of the pressure plates 24, 25.

In principle, spring elements could also be arranged only on one side. Thus, one of the pressure plates 24, 25 could also be omitted and the relevant primary contact ring 11 could rest by way of its support section 11a directly on the relevant housing part 13, 14.

By virtue of the spring force of the spring elements 26, the angle 48 between the support portions 11a, 12a and contact portions 11b, 12b of the contact rings 11, 12 is somewhat greater in the assembled state than in the unloaded state of the contact rings 11, 12, this angle 48 being measured in each case on that side of the respective contact ring 11, 12 on which the contact surface 11d, 12d lies. This enlargement of the angle 48 is preferably less than 5°. A value of more than 0.5° is preferred. As a result, the inclination of the contact portions 11b, 12b in the assembled state precisely matches the inclination of the contact surface 27a of the respective roller 27.

The thickness of the metal sheet from which the contact rings 11, 12 are made is also selected so as to correspond to the current intensity for which the contact arrangement is designed. The thickness of the metal sheet is advantageously in the range from 0.5 mm to 2 mm. For example, the thickness of the sheet is in the range from 0.5 mm to 1 mm for current intensities of up to 100 amperes and in the range of 1 mm to 2 mm for current intensities of up to 1000 amperes.

At least three rollers 27 distributed around the circumference are preferably provided for the purpose of interacting with a respective pair of contacts. For reasons of space, three rollers is preferred and more than four rollers is less preferred. The roller support ring 29 is thus self-centering by virtue of the interaction of the rollers 27 with the primary and secondary contact rings 11, 12. An additional mounting of the roller support ring is not necessary.

The cables 23, which corotate with the rotor 15 and are connected to the secondary contact rings 12, are guided out axially (in relation to the longitudinal center axis 16) through an opening 13b in the housing part 13. If the electrical contact arrangement is combined with a rotary feedthrough 2 as shown in the exemplary embodiment, the cables 23 can be passed through the central opening of the rotary part 6.

In the exemplary embodiment, the cables 22 connected to the primary contact rings 11 are guided out through grooves 14b at the edge of the housing part 14.

If the rotor 15 is rotated with respect to the housing formed by the housing parts 13, 14, for example by driving the rotary part 6 of the rotary feedthrough 2, the roller support rings 29 rotate at half the speed.

The housing parts 13, 14 are connected to one another by axially aligned screws, which are not illustrated. The housing of the cone contact unit 1a could also have further or differently formed housing parts.

In the exemplary embodiment shown, the electrical contact arrangement has two poles, i.e. there are two pairs of contacts each consisting of a primary and a secondary contact ring, between each of which at least one roller rolls, the secondary contact rings being arranged on a common rotor. A contact arrangement according to the invention could also have only one pole or more than two poles. In a design with only one pole, the rotor 15 would thus have only one secondary contact ring 12. For example, the contact arrangement according to the invention could have four poles for the purpose of transmitting alternating current (three phases and a neutral conductor). The cone contact unit 1a illustrated in the exemplary embodiment could be duplicated for this purpose, for example.

In the exemplary embodiment shown, the contact arrangement according to the invention also has a ball contact unit 1b. This serves in particular for the transmission of electrical signals (data). The current intensities to be transmitted are therefore relatively low, preferably less than 1 A.

The ball contact unit has a rotor 34, which is mounted rotatably about the longitudinal center axis 16 and in the exemplary embodiment has two contact disks 35. The contact disks 35 are arranged on rotor parts 36, 37 which are connected to one another and which together form a base body of the rotor 34. Such a base body could also have more than two parts or have a unipartite form. The rotor base body is mounted rotatably with respect to a housing of the ball contact arrangement. This housing is formed by the housing parts 38, 39 in the exemplary embodiment. The housing parts 38, 39 can be connected by screws. Such a housing could also have more than two parts or differently formed parts. In order to mount the rotor 34 rotatably with respect to the housing, provided in the exemplary embodiment are ball bearings 40, 41 which are arranged with their inner rings on the rotor parts 36, 37. The outer rings of the ball bearings are held in seats 38a, 39a of the housing parts 38, 39.

The contact disks 35 each have multiple annular conductor tracks 35a that are coaxial with the longitudinal center axis 16. The conductor tracks are arranged on the sides of the contact disks 35 that are directed away from one another.

Furthermore, the ball contact unit 1b has a set of mating contacts 42 for each of the contact disks 35. A respective set of mating contacts 42 is formed by multiple annular mating contacts 42 that are coaxial to the longitudinal center axis 16 and have different diameters. The diameters of the mating contacts 42 of a respective set correspond to the diameters of the conductor tracks 35a of the associated contact disk 35.

On their sides remote from the contact disks, the mating contacts 42 protrude into annular grooves 38b, 39b in the housing parts 38, 39. Spring elements 43, which are in the form of helical springs in the exemplary embodiment, are arranged between the mating contacts 42 and the bases of the grooves 38b, 39b. For each of the mating contacts 42, there are multiple helical springs distributed circumferentially around the longitudinal center axis 16; in the exemplary embodiment there are four helical springs.

Electrical conductors 44a of cables 44 are connected to the mating contacts 42, for example by being soldered on. Electrical conductors of cables 45 are connected to the conductor tracks 35a of the contact disk 35.

Multiple contact balls 46 distributed circumferentially around the longitudinal center axis 16 roll between a respective conductor track 35a of a respective contact disk 35 and the associated annular mating contact 42. These contact balls 46 are arranged in openings in a respective ball guiding disk. A ball guiding disk 47 with the contact balls 46 that it guides is provided between a respective contact disk 35 and the associated annular mating contacts 42.

The contact balls 46 consist overall of an electrically conductive material or are coated with such a material.

In the exemplary embodiment, three contact balls 46 arranged around the longitudinal center axis 16 at regular intervals, that is to say offset by 120° in each case, are assigned to each conductor track 35a and to the associated mating contact 42. At least three contact balls are preferred, more than three contact balls are conceivable and possible.

In order to enlarge the intervals between the contact balls 46 assigned to adjacent conductor tracks 35a and to adjacent mating contacts 42, these contact balls are preferably arranged offset with respect to one another in terms of their angular position about the longitudinal center axis 16.

The ball guiding disk 47 thus constitutes a type of ball cage for the contact balls 46. The contact balls 46 are preferably held in the openings in the ball guiding disk 47 in such a way that the contact balls 46 cannot fall out during assembly.

The mating contacts 42 are thus pressed against the contact balls 46 by the spring elements 43 and the contact balls 46 are thus pressed against the conductor tracks 35a of the contact disks 35.

Owing to the individually spring-mounted mating contacts 42, size tolerances of the contact balls 46 can be accommodated, in particular in combination with the fact that three respective contact balls 46 are provided for each conductor track 35a or mating contact 42.

The mating contacts 42 are held against rotation about the longitudinal center axis 16 by virtue of their connection to the electrical conductors 44a of the cables 44. A rotation-prevention means could also additionally be obtained by further measures.

The cables 45, the electrical conductors of which are connected to the conductor tracks 35a of the contact disks 35, are preferably guided out axially through openings in the ball guiding disk 47 and in the housing part 38. These cables 45 could also be passed through the central axial opening in the cone contact unit 1a. On the other hand, the cables 45 could also be guided out on the opposite side of the ball contact unit 1b through the openings in the other ball guiding disk 47 and the other housing part 39.

In principle, it would also be conceivable and possible for only one of the two sets of mating contacts 42 to be assigned spring elements 43, which press the contact balls 46 arranged in the two ball guiding disks 47 against the conductor tracks 35 and opposite mating contacts 42.

Instead of helical springs, other spring elements could also be provided, for example at least one annular leaf spring could be present for each mating contact 42.

The rotor 34 of the ball contact unit 1b could also have only a single contact disk 35 with associated mating contacts 42, in which case only a single ball guiding disk 47 with contact balls 46 would be present. On the other hand, more than two contact disks 35 could also be present, for example the ball contact unit 1b illustrated could be present twice.

The rotors 15 and 34 of the cone contact unit 1a and ball contact unit 1b are rotationally conjointly connected to one another. For example, the rotor housing part 18 of the rotor 15 comprises prongs 18a with depressions in between and the rotor part 36 of the rotor 34 comprises prongs 36a with depressions in between and the prongs 18a, 36a of the one part engage in the depressions of the other part.

In principle, a kinematic reversal would also be conceivable and possible in the sense that the rotor 15 of the cone contact unit and, if it is present, the rotor 34 of the ball contact unit are rotationally fixed with respect to the longitudinal center axis 16 and the housing of the cone contact unit 1a and, if it is present, the housing of the ball contact unit 1b rotates about the longitudinal center axis 16.

Key to the Reference Signs

| | |
|---|---|
| 1 | Contact arrangement |
| 1a | Cone contact unit |
| 1b | Ball contact unit |
| 2 | Rotary feedthrough |
| 3 | Housing part |
| 4 | Channel |
| 5 | Annular groove |
| 6 | Rotary part |
| 7 | Ball bearing |
| 8 | Ball bearing |
| 9 | Channel |
| 10 | Bore |
| 11 | Primary contact ring |
| 11a | Support portion |
| 11b | Contact portion |
| 11c | Contacting tab |
| 11d | Contact surface |
| 12 | Secondary contact ring |
| 12a | Support portion |
| 12b | Contact portion |
| 12c | Contacting tab |
| 12d | Contact surface |
| 13 | Housing part |
| 13a | Seat |
| 13b | Opening |
| 14 | Housing part |
| 14a | Seat |
| 14b | Groove |
| 15 | Rotor |
| 16 | Longitudinal center axis |
| 17 | Rotor housing part |
| 17a | Prong |
| 17b | Latching arm |
| 18 | Rotor housing part |
| 18a | Prong |
| 18b | Latching arm |
| 19 | Rotor base part |
| 20 | Ball bearing |
| 21 | Ball bearing |
| 22 | Cable |
| 22a | Electrical conductor |
| 23 | Cable |
| 23a | Electrical conductor |
| 24 | Pressure plate |
| 24a | Slot |
| 25 | Pressure plate |
| 25a | Slot |
| 26 | Spring element |
| 27 | Roller |
| 27a | Contact surface |
| 28 | Axis of rotation |
| 29 | Roller support ring |
| 29a | Journal |
| 30 | Ball bearing |
| 31 | Contact line |
| 32 | Contact line |

33 Angle
34 Rotor
35 Contact disk
35a Conductor track
36 Rotor part
36a Prong
37 Rotor part
38 Housing part
38a Seat
38b Groove
39 Housing part
39a Seat
39b Groove
40 Ball bearing
41 Ball bearing
42 Mating contact
43 Spring element
44 Cable
44a Electrical conductor
45 Cable
46 Contact ball
47 Ball guiding disk
48 Angle

1. An electrical contact arrangement comprising:
at least one pair of contacts formed by a primary contact ring and a secondary contact ring, which are rotatable with respect to one another about a longitudinal center axis and each of which has a contact surface having a cone envelope shape and surrounds the longitudinal center axis, the secondary contact ring is arranged on a rotor which is mounted rotatably with respect to a housing;
at least one roller which rolls between the primary and the secondary contact rings of a respective pair of the contacts and is mounted rotatably about an axis of rotation at right angles to the longitudinal center axis, the roller has a contact surface which has a cone envelope shape, surrounds the axis of rotation, and forms a respective line contact, running along a respective contact line, with the contact surfaces of the primary and secondary contact rings;
at least one spring element which presses the contact surface of the roller against the contact surfaces of the primary and secondary contact rings, a spring force of the at least one spring element acts parallel to the longitudinal center axis;
wherein a support portion of the secondary contact ring rests on a rotor base part and a contact portion of the secondary contact ring, said contact portion comprising the contact surface of the secondary contact ring, adjoins the support portion radially outwardly,
a support portion of the primary contact ring rests on a pressure plate, which is acted upon by the at least one spring element and is mounted axially displacably with respect to a housing part of the electrical contact arrangement, and a contact portion of the primary contact ring adjoins the support portion radially outwardly and comprises the contact surface, and
an angle, measured on a side of the contact surface, between the contact portion and the support portion of the respective primary and secondary contact ring is greater in an assembled state than in an unloaded state, and an inclination of the respective contact portion in the assembled state matches the inclination of the contact surface of the respective roller with which it interacts.

2. The electrical contact arrangement as claimed in claim 1, wherein the axis of rotation of the at least one roller and straight lines on which lie the contact lines which are formed by the contact surface of said roller with the contact surface of the primary and the secondary contact rings have a common intersection point which lies on the longitudinal center axis.

3. The electrical contact arrangement as claimed in claim 1, wherein there are at least three of the rollers, which are spaced apart around the longitudinal center axis, are mounted rotatably about respective axes of rotation at right angles to the longitudinal center axis, have contact surfaces having a cone envelope shape, and roll between the primary and the secondary contact rings of a respective one of the at least one pair of contacts.

4. The electrical contact arrangement as claimed in claim 3, wherein there are three of the rollers that are spaced apart around the longitudinal center axis by 120° in each case, and roll between the primary and the secondary contact rings of a respective one of the pair of contacts.

5. The electrical contact arrangement as claimed in claim 3, wherein the rollers are mounted rotatably about the respective axis of rotation on a roller support ring, and the roller support ring is centered in relation to the longitudinal center axis by the interaction of the rollers with the contact surfaces of the primary and the secondary contact ring.

6. The electrical contact arrangement as claimed in claim 1, wherein the at least one pair of contacts comprises first and second pairs of contacts, which are each formed by one of the primary and one of the secondary contact ring, the rotor comprises the secondary contact rings of the first and the second pair of contacts, and the primary contact rings are rotationally conjointly connected to housing parts arranged on opposite sides of the rotor.

7. The electrical contact arrangement as claimed in claim 1, wherein the angle, measured on the side of the contact surface, between the contact portion and the support portion of the respective primary and secondary contact rings is more than 0.5° greater in the assembled state than in the unloaded state.

8. The electrical contact arrangement as claimed in claim 1, wherein the angle, measured on the side of the contact surface, between the contact portion and the support portion of the respective primary and secondary contact rings is less than 5° greater in the assembled state than in the unloaded state.

9. The electrical contact arrangement as claimed in claim 1, wherein the contact portions of the primary and secondary contact rings in the assembled state are aligned at an angle in relation to the respective support portion from which they extend.

10. The electrical contact arrangement as claimed in claim 1, wherein, for transmitting electrical signals, the contact arrangement further includes a ball contact unit, comprising:
at least one contact disk with multiple annular conductor tracks coaxial with the longitudinal center axis,
at least one set of multiple mating contacts which are concentric in relation to the longitudinal center axis and diameters of which correspond to diameters of the annular conductor tracks of the contact disk,
at least one ball guiding disk arranged between the at least one contact disk and the mating contacts interacting with the contact disk, and
contact balls guided by the ball guiding disk that roll between a respective one of the conductor tracks and the annular mating contact assigned to said conductor track.

11. The electrical contact arrangement as claimed in claim 10, further comprising at least one spring element that interacts with each of the annular mating contacts and presses the annular mating contact against the contact balls rolling between said mating contact and the associated conductor track.

12. The electrical contact arrangement as claimed in claim 10, wherein to axially displacably guide the mating contacts, the annular mating contacts protrude into annular grooves in a housing part of the ball contact unit.
